(19) United States
(12) Patent Application Publication
(10) Pub. No.: US 2015/0221456 A1
(43) Pub. Date: Aug. 6, 2015

(54) ACTUATOR FOR LOW-, MEDIUM- OR HIGH-VOLTAGE SWITCHGEARS

(71) Applicant: ABB TECHNOLOGY AG, Zurich (CH)

(72) Inventors: Dalibor KOPP, Dusseldorf (DE); Robby ZITZMANN, Ratingen (DE)

(73) Assignee: ABB TECHNOLOGY AG, Zurich (CH)

(21) Appl. No.: 14/685,041

(22) Filed: Apr. 13, 2015

Related U.S. Application Data
(63) Continuation of application No. PCT/EP2013/003000, filed on Oct. 4, 2013.

(30) Foreign Application Priority Data
Oct. 11, 2012 (EP) 12007042.0

(51) Int. Cl. H01H 5/14; H01H 3/42

(52) U.S. Cl. CPC H01H 5/14; H01H 3/42; H01H 2003/323

(57) ABSTRACT

The disclosure relates to an actuator for low-, medium- or high-voltage switchgears with a drive to move at least one movable contact, with mechanical actuation energy transmission elements between the drive and the movable contact system, in which rotating and/or translating elements mechanically correspond to at least one position determining switch. To compensate mechanically for torsion and/or bending effects, the rotating and/or the translating element is divided mechanically into a first part and a second part, movable relative to each other, a tappet element being between the parts. A relative mechanical deviation of the first part to the second part can be dimensioned such that it can compensate for the mechanical deviation caused by torsion and/or bending and/or tolerance of transmission elements.

### RELATED APPLICATION(S)

This application claims priority as a continuation application under 35 U.S.C. §120 to PCT/EP2013/003000, which was filed as an International Application on October 4, 2013 designating the U.S., and which claims priority to European Application 12007042.0 filed in Europe on October 11, 2012. The entire contents of these applications are hereby incorporated by reference in their entireties.

### FIELD

The disclosure relates to an actuator for low-, medium- or high-voltage switchgears with a drive to move at least one movable contact, with mechanical actuation energy transmission elements between the drive and the movable contact system, in which rotating and/or translating elements are mechanically corresponding to at least one position determining switch and a method of operating the same.

### BACKGROUND INFORMATION

To control a motor driven actuator in switchgears and to stop it in defined position, it is known, to actuate snap switches by cam wash, lever pins or other mechanical elements. This can be also used for electrical position indication too. As long as the switch is forced by the mechanical element, the position can be clearly defined. A known design is to place a cam on a shaft. This cam can force the snap switch in its defined position when the shaft rotates. Also, a translating actuation can be used instead of rotating actuation.

Known snap switches can be used to switch a motor OFF at an exact position. Due to the direct actuation dependent parts (tolerances) a high effort for adjustment may be required. See FIG. 5.

The left side of FIG. 5 shows the actuation state with a known rotating version, forced position for two positions. The right side of FIG. 5 shows the unforced case based on tolerances.

Due to elastic deformation, caused by high forces during the actuation, the contact to the snap switch can be lost.

Additionally all bigger tolerances of the involved part can have the result that the system could lose the contact to the snap switch although the driven element is still in its defined position.

Because of vibrations, or by too high manual forces in combination with the system's elasticity, the system can lose contact to the snap switch resulting in a wrong status indication/undefined status for motor control, as shown in the right side of FIG. 5.

### SUMMARY

An actuator for low-, medium- or high-voltage switchgears is disclosed having a drive for at least one movable contact, and a mechanical actuation energy transmission element between the drive and a movable contact system, the actuator comprising: a rotating and/or translating element mechanically corresponding to at least one position determining switch, wherein the rotating and/or the translating element is divided mechanically into first and second parts movable relative to each other, a tappet element being arranged between the parts, a relative mechanical deviation of the first part to the second part being dimensioned for compensating a mechanical deviation caused by at least one of torsion, bending, and tolerance of transmission elements.

A method is also disclosed of operating an actuator for low-, medium- or high-voltage switchgears having a drive for moving at least one movable contact, and mechanical actuation energy transmission elements between the drive and a movable contact system, with a rotating and/or translating element mechanically corresponding to at least one position determining switch, the method comprising: dividing the rotating and/or the translating element mechanically into first and second movable parts that move relative to each other, a tappet element being arranged between the parts; and arranging a relative mechanical deviation of the first part to the second part with dimensions for compensating a defined mechanical deviation caused by at least one of torsion, bending, and tolerance of the transmission elements.

### BRIEF DESCRIPTION OF THE DRAWINGS

FIG. 1, left side, shows a front view of the actuation elements according to an exemplary embodiment; the right side of FIG. 1 shows a perspective view of the new actuation;

FIG. 2 on the left side and the right side shows how the system according to an exemplary embodiment of the disclosure works if a deviation regarding shaking, earthquake or occurring tolerances happens;

FIG. 3 shows in an exemplary embodiment of the disclosure, that this actuation can also be used for more switches;

FIG. 4 shows an exemplary embodiment of the disclosure, in which this principle is used for translating also linear actuation; and

FIG. 5 on the left shows the actuation state with a rotating version, forced position for two positions; the right side of FIG. 5 shows the unforced case based on tolerances.

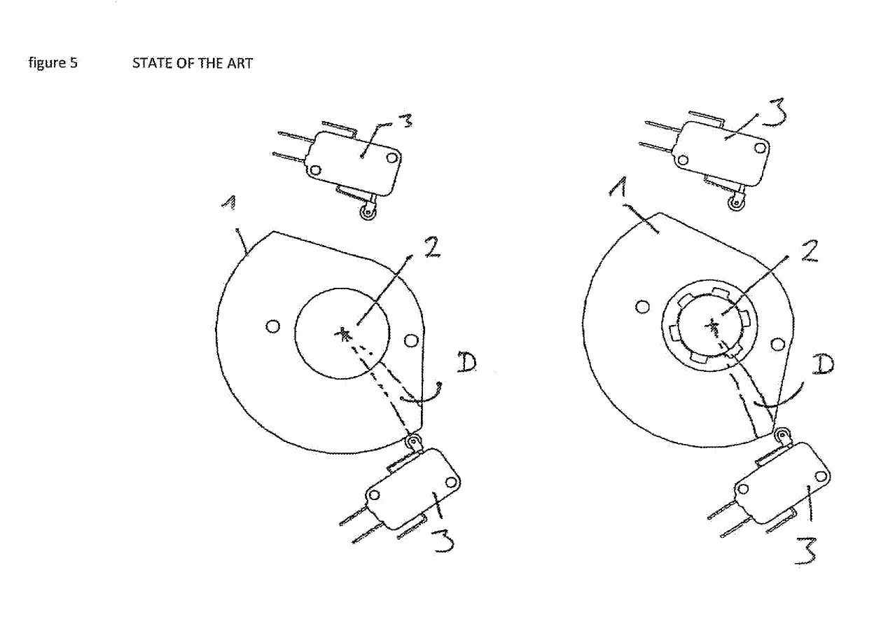

### DETAILED DESCRIPTION

Exemplary embodiments of the disclosure can overcome mechanical issues of known actuators, and enhance the performance for such actuators.

According to exemplary embodiments of the disclosure, a rotating and/or the translating element can be divided mechanically into two parts moveable relative to one another, a movable first part and second part such that via a tappet element between the first part and the second part, a relative mechanical deviation of the first movable part to the second movable part is dimensioned to compensate for mechanical deviation caused by torsion and/or bending and/or tolerance of transmission elements.

The phrase “mechanical deviation”, can have the following definition:

A mechanical deviation occurs relatively between a fixed position of a first part and relatively to a moved position of a second part, if force transmitting elements are used. That means, that the relatively deviation occurs, if the mechanical force transmitting element gets elastic bending or torsion under the driving force impact in one direction, against a mechanical friction force in the opposite direction. So this results in the fact that the driving path X of such a transmission element differs from the resulted path X—Delta, at the end of the transmission element. This is caused by mechanical bending, torsion or other elastic force components in the material of the mechanical force transmitting element.

In exemplary embodiments of the disclosure, the rotating and/or the translating element is divided mechanically into two parts, relatively moveable to each other: a movable first part and moveable second part such that, via a tappet element between the first part and second part, a relative mechanical deviation of the first movable part to the second movable part is dimensioned such that it can compensate for mechanical deviation caused by torsion and/or bending and/or tolerance of transmission elements.

The aforesaid deviation or shifts can be compensated in a defined way, so that a very precise mechanical position can be possible.

Exemplary embodiments include a more exact actuation of the snap switches. Furthermore, loss of mechanical contact regarding tolerances can be prevented. The system can also be easier to adjust.

An exemplary advantage can be that exact contacting of the snap switch after endurance based abrasion of primary parts can result. The system can have a higher economic result by accommodating larger possible tolerances of dependant parts.

An exemplary embodiment of the disclosure includes the first part directly fixed or coupled to or with the transmission element, and the second part coupled via the tappet element or elements with a defined mechanical hysteresis. In an exemplary embodiment, the mechanical hysteresis is realized by the tappets mechanically corresponding interacting openings such that a defined deviation for the aforesaid mechanical hysteresis is affected.

In order to produce a reproductive mechanical hysteresis, it is proposed that braking elements are implemented such that relative movement between the first part and the second part is influenced by a braking force in order to realize the aforesaid hysteresis.

For the mechanical engagement of the braking force, it is proposed that the braking elements include a cartridge with a circumferential groove or surface, in which or, on which, a braking element in form of a slinging element or a slinging spring accesses into the groove or on the surface in order to effect a defined braking force.

In an exemplary embodiment according to the disclosure, in case of an application only on one transmission element, the slinging element can be retained mechanically with the free side at a support or at a housing element.

In an exemplary embodiment according to the disclosure, in case of a parallel arrangement of two transmission elements, the slinging element can have two braking slinging ends, and each end is coupled to one of the two transmission elements.

In an exemplary embodiment according to the disclosure, the movable parts 4 and 5 are rotating elements.

In an exemplary embodiment according to the disclosure the movable parts 4 and 5 are translating elements.

An exemplary embodiment according to the disclosure can provide a common actuation of one or more snap switches which will force the snap switches in one direction. The tolerance based deviation which is founded in that a part which belongs to the cinematic chain will have no effect on the actuation of the snap (auxiliary) switches anymore and the snap (auxiliary) switches will not lose the signal regarding elastically deformation because of the high forces, deviation regarding tolerances, or shaking induced by earthquake.

According to exemplary embodiments of the disclosure, the adjusting time can be decreased. The tolerances of the parts which belong to the cinematic chain can be chosen in a way that they can be produced, with higher economic result.

According to a method for operating such an actuator of an exemplary embodiment of the disclosure, the rotating and/or the translating element can be divided mechanically into two parts movable relative to each other (i.e., parts 4 and 5) such that via a tripping element between part 4 and part 5, a relative mechanical deviation D of the movable part 4 to the movable part 5 is dimensioned in such that it compensates a defined or predefined mechanical deviation D caused by torsion and/or bending inside the drive and/or the drive-gear.

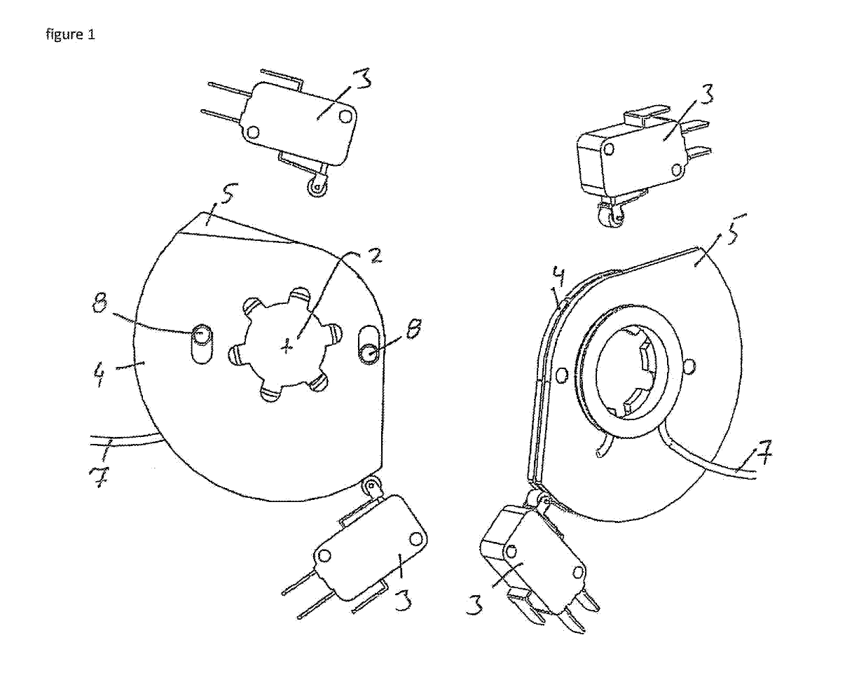

An exemplary embodiment of the disclosure is shown in FIG. 1, left side, which displays the front view of the actuation elements. The right side of FIG. 1 shows a perspective view of the new actuation. A driving cam 4 is placed and connected mechanically with a rotating shaft 2. A driven cam 5 bears on the driving cam 2, but not connected with the shaft directly. The driven cam 5 is connected with the driving cam 4 by a pin 8, in that way, that a tripping deviation can be created. The driven cam 5 is decelerated by a braking spring 7.

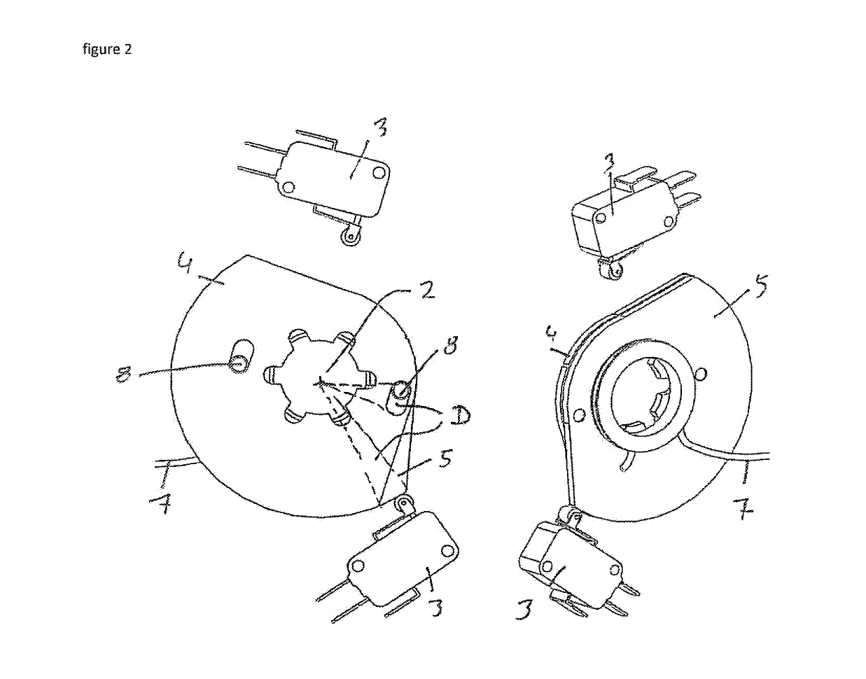

FIG. 2 on the left side and the right side shows, how the system works if a deviation regarding shaking, earthquake or occurring tolerances happens. The driving cam 4 tends to lose the contact to the switch. But due to the braking spring 7, the driven cam 5 keeps in mechanical contact with the switch. If the system will be actuated deliberately, the driving cam 4 will move the driven cam 5 also because of the defined moving deviation D by pin 8 between part 4 and 5.

FIG. 2 shows a new actuation system with mechanical hysteresis active for two positions.

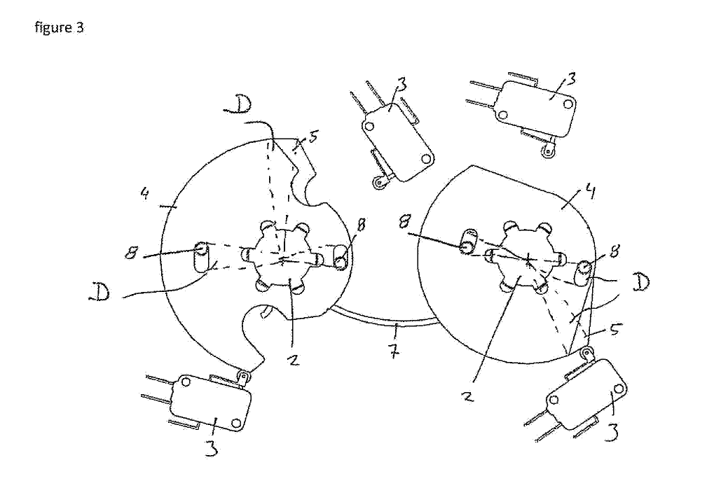

FIG. 3 shows in an exemplary embodiment of the disclosure, that this actuation can also be used for more switches. It can be used for one and more positions. Mechanical hysteresis can be active for four positions.

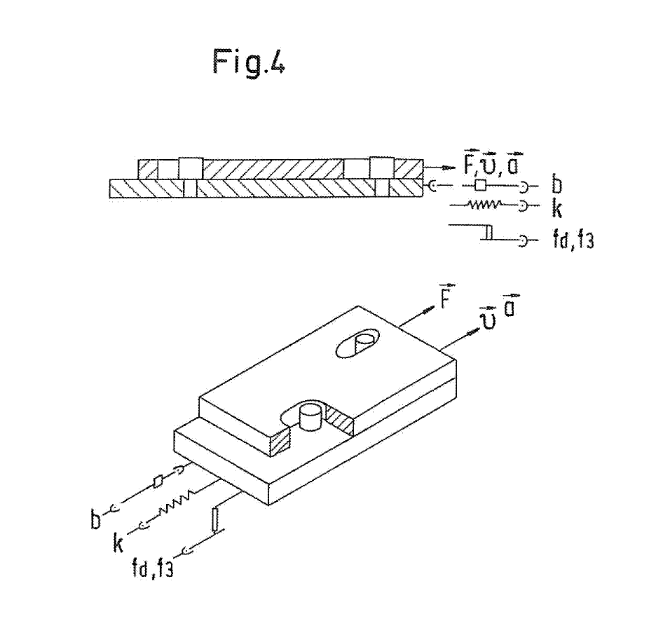

FIG. 4 shows an exemplary embodiment of the disclosure, in which this principle is used for translating also linear actuation. The principle is the same, as described above to the rotating movement. Instead of a spring an attenuator, buffer or friction itself can be used.

Thus, it will be appreciated by those skilled in the art that the present invention can be embodied in other specific forms without departing from the spirit or essential characteristics thereof. The presently disclosed exemplary embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE SIGNS

1 lever

2 rotating shaft

3 snap switch

4 driving cam

5 driven cam

6 braking spring

7 pin

D deviation

What is claimed is:

1. An actuator for low-, medium- or high-voltage switchgears having a drive for at least one movable contact, and a mechanical actuation energy transmission element between the drive and a movable contact system, the actuator comprising:
a rotating and/or translating element mechanically corresponding to at least one position determining switch, wherein the rotating and/or the translating element is divided mechanically into first and second parts movable relative to each other, a tappet element being arranged between the parts, a relative mechanical deviation of the first part to the second part being dimensioned for compensating a mechanical deviation caused by at least one of torsion, bending, and tolerance of transmission elements.

2. The actuator for low-, medium- or high-voltage switchgears according to claim 1 in combination with a drive for a moveable contact, and a mechanical actuation energy transmission element, wherein the first part is directly fixed or coupled to or with the transmission element and the second part is coupled via the tappet element with a defined mechanical hysteresis.

3. The actuator for low-, medium- or high-voltage switchgears according to claim 2, wherein the mechanical hysteresis is realized by at least one tappet comprising:
mechanically corresponding interacting openings such that a defined deviation for the mechanical hysteresis is affected.

4. The actuator according to claim 2, comprising:
braking elements implemented such that relative movement between the first part and the second part will be influenced by a braking force, in order to realize the hysteresis.

5. An actuator for low-, medium- or high-voltage switchgears according to claim 4, wherein the braking elements comprise:
a cartridge with a circumferential groove or a surface, in which a braking element formed as a slinging element or a slinging spring accesses into the groove in order to effect a defined braking force.

6. An actuator for low-, medium- or high-voltage switchgears according to claim 5, wherein for an application only on one transmission element, the slinging element is retained mechanically with a free side at a support or at a housing element.

7. An actuator for low-, medium- or high-voltage switchgears according to claim 5, wherein for a parallel arrangement of two transmission elements, the slinging element comprises:
two braking slinging ends wherein each end is coupled to one of the two transmission elements.

8. An actuator according to claim 1, wherein the movable parts are rotating elements.

9. An actuator according to claim 1, wherein the movable parts are translating elements.

10. A method of operating an actuator for low-, medium- or high-voltage switchgears having a drive for moving at least one movable contact, and mechanical actuation energy transmission elements between the drive and a movable contact system, with a rotating and/or translating element mechanically corresponding to at least one position determining switch, the method comprising:
dividing the rotating and/or the translating element mechanically into first and second movable parts that move relative to each other, a tappet element being arranged between the parts; and
arranging a relative mechanical deviation of the first part to the second part with dimensions for compensating a defined mechanical deviation caused by at least one of torsion, bending, and tolerance of the transmission elements.
